(19) United States
(12) Patent Application Publication
(10) Pub. No.: US 2004/0230531 A1
(43) Pub. Date: Nov. 18, 2004

(54) System for handling electronic messages with the senders' financial guarantee

(76) Inventor: Harold Weiss, Wayland, MA (US)

Correspondence Address: Gregory P. Gadson, Esq., 19375 Amber Way, Noblesville, IN, 46060, US

(21) Appl. No.: 10/800,591

(22) Filed: Mar. 15, 2004

Related U.S. Application Data
(60) Provisional application No. 60/466,363, filed on Apr. 29, 2003.

(51) Int. Cl. G06F 15/16; G06F 17/60; H04L 9/00

(52) U.S. Cl. 705/53

(57) ABSTRACT

A method of regulating electronic communications at least includes, via a sender, purchasing a satisfaction bond to be coupled with a communication, the bond being adapted to be forfeited if a recipient of the communication to which the bond is coupled rejects the communication, and sending a message intended for a recipient accompanied by the bond. The bond is established by at least, via the sender, pledging or transferring a res in exchange for the bond, and generating a block of secure data, the secure data comprising a secure certificate containing at least sender identity indicia, a digital signature, a hashing code, and a hash of the message for which the bond is to accompany. The method further at least includes, prior to receipt of the message by the intended recipient, verifying the legitimacy of the bond via a third party, subjecting the message to a filter when the bond is not determined to be legitimate or the message is not accompanied by a bond, the filter being adapted to accept or reject messages based upon predetermined criteria, and not subjecting the message to a filter when the bond is determined to be legitimate.

### CROSS-REFERENCE TO RELATED APPLICATIONS

This application is based on and claims the priority of U.S. Provisional Patent Application Ser. No. 60/466,363, filed Apr. 29, 2003 for “System for Handling Electronic Messages with the Senders' Financial Guarantee.”

### BACKGROUND OF THE INVENTION

1. Field of the Invention

The present invention generally relates to methods for reducing unwanted electronic communications, with a non-limited emphasis upon “spam” and other forms of unwanted electronic mail. More particularly, the present invention relates to modifications to systems for reducing unwanted electronic communications for compatibility of such systems with all electronic communication recipients.

2. Background

As is well known, electronic mail (“e-mail”) messages can be sent and received from almost any location using a computer or other device with a MODEM and an available telephone line. At the time of the initial filing of the application upon which this Letters Patent is based, well over 300 million hourly e-mail messages, and approximately 3 trillion yearly e-mail messages, were being sent to computer users.

To the chagrin of many e-mail users, much of the messages and attached files they receive can be classified as “spam.” In general, spam is unsolicited, mass-transmitted e-mail analogous to “junk” mail received by postal customers. Unlike postal junk mailers, “spammers” have very little increased cost associated with sending mass e-mailings, and are exponentially wreaking havoc.

Not only does spam overwhelm users' system resources and commandeer their time in order to delete unwanted messages, but it also transmits undesirable subject matter for many users. The undesirable subject matter for some, ranges from unwanted commercial solicitation, to chain mailings, to sexually explicit material.

One simplistic prior art approach to solving the problem of eliminating unwanted e-mail messages is for the user to compile a list of acceptable senders' e-mail addresses, or a list of banned senders' addresses, or both. Software on the user's computer system would then reject all incoming e-mail which is from a banned source, or which is from an unauthorized source. This approach has several problems; among them, rejecting perfectly legitimate e-mails the user would indeed have an interest in, simply because the sender's address does not appear on the list of authorized senders. This approach also places an untenable burden upon the user to constantly update the aforementioned list in order to avoid improper rejections. This approach also lacks the ability to recognize desirable senders whose e-mail addresses have changed unbeknownst to the recipient.

Another approach to eliminating unwanted e-mail messages is to install a filter on the user's system, or at the level of the Internet Service Provider (ISP) administering the user's e-mail account. Prior to presenting an e-mail message to the user, the filter peruses the e-mail for words or character strings that have been identified as tending to be associated with an undesirable communication. Regardless of how sophisticated these filters are, they often reject perfectly legitimate e-mail messages for failure to place the forbidden words in context. These filters also fail to reject undesirable messages that are cleverly worded to appear innocuous to filters, but yet contain subject matter the user would not otherwise like to receive.

In yet another approach, the user employs a third party to administer a filtering service for screening all e-mail messages. All e-mail sent to a service subscriber's address is routed to a server or other instrumentality under the control of the filter service operator. The filtering service combines software and human screeners to review all messages, and pass to the subscriber, only those messages meeting the subscriber's positive and/or negative criteria. This approach adds extra cost to e-mail service, and while it may eliminate more of the cleverly worded but yet undesirable messages, nonetheless suffers from the same software limitations as previously mentioned approaches. It is also prone to human error. Compounding these problems is a loss of privacy on the part of the subscriber, as well as a requirement that the subscriber relinquish a degree of control to third parties who lack to personal experience and information to accept those messages which may appear to be forbidden on the surface, but might actually be desirable for receipt nonetheless.

A newer approach advocated, but yet to be successfully implemented commercially, is to charge an e-mail sender a fee for every message he or she sends. This is designed to make the price of spamming cost-prohibitive, while not leading to raised costs for typical e-mail users. While this can be controlled by ISPs who service the spammers, it will not discourage spammers whose ISPs do not charge for individual mail. Further, this moves away from the concept of e-mail for the masses which is not encumbered by a fee or taxing event for every message. It also requires those who send a large number of legitimate, desirable e-mails that are not seen as a nuisance, to pay unacceptably high up-front fees.

A further proposed refinement of the latter approach requires e-mail users to install special software that automatically assesses a fee (payable to the user) for each e-mail message from an unrecognized sender. The fee can be collected via the Internet Service Provider (ISP) where the sender and recipient have a common ISP. If not, the multiple ISPs involved can cooperate to charge the fee. If the user determines that the e-mail was desirable, he or she can cancel the charge. The fee is a matter of design choice, and can be, for example, in the $1 to $3 range.

While the latter approach may indeed serve as a deterrent to sending spam, it includes facets that make it impractical. Automatically and randomly charging senders having addresses unknown to the recipient, without their knowledge that they could be charged does not permit e-mail senders to adequately plan their costs associated with sending e-mails. Further, there is a financial incentive for some recipients to abuse the system by not canceling fees for legitimate e-mails, simply to collect the fee.

It should be noted that the problems associated with e-mail and unwanted messages are also present with other forms of electronic communication, such as, for example, telephone calls and facsimile transmissions. Solutions to reducing unwanted messages and contact for these other forms of communication are also inadequate.

U.S. Pat. No. 6,697,462, assigned to Vanquish, Inc., also the assignee of the present application, addressed the above-mentioned problems generally by allowing a recipient or prospective recipient of electronic communications to require that senders of these messages post a bond along with, or prior to sending the electronic communication. Further, (with knowledge to the sender) the bond is forfeited if the recipient rejects the communication upon receiving it or considering it. This is summarized in the aforementioned letters patent in the following manner:

[T]he present invention provides a method of regulating electronic communications. The method at least includes the steps of receiving a communication from a sender for a designated recipient, comparing sender identity indicia attached to the communication with stored sender identity indicia in a database under the control of the recipient, and presenting the communication to the recipient for acceptance or rejection, when the sender identity indicia is determined to be acceptable. The method further at least includes the steps of sending a return message to the sender indicating that a bond must be posted when the sender identity indicia is not determined to be acceptable, and that money associated with the bond shall be forfeited if the communication is presented to the recipient and the recipient rejects the communication, dissolving the bond when the recipient accepts the communication, and causing the money associated with the bond to be forfeited when the recipient rejects the communication.

The present invention also provides a system for regulating electronic communications. The system includes, inter alia, at least a communication server adapted to receive a communication from a sender for a designated recipient, a sender identity indicia database adapted to store sender identity indicia under the direction of the recipient corresponding to acceptable or unacceptable sender identities, a comparator adapted to compare sender identity indicia attached to the communication with stored sender identity indicia database, and a bond establisher adapted to enable communication senders to establish bonds. The communication server is further adapted to present the communication to the recipient for acceptance or rejection, when the sender identity indicia is determined to be acceptable according to the output and interpretation of the comparator, and send a return message to the sender indicating that a bond must be posted when the sender identity indicia is not determined to be acceptable, and that money associated with the bond shall be forfeited if the communication is presented to the recipient and the recipient rejects the communication. The system is also adapted to dissolve the bond when the recipient accepts the communication, and cause the money associated with the bond to be forfeited when the recipient rejects the communication.

The present invention further provides a method of regulating electronic communications that at least includes the steps of receiving a communication from a sender for a designated recipient, and if the communication is accompanied by a posted bond, the amount of which is specified by the recipient, the recipient providing a guarantee that the communication will be accepted.

A related approach is for ISPs to utilize appropriate software that allows communications from senders to bypass spam filters when they are accompanied by the appropriate bonds, by detecting the bond and verifying its authenticity. Legitimate marketers who responsibly target customers can therefore reach intended customers without having those communications blocked by ISP spam filters. ISPs under this scenario will have their concerns abated by knowing that such communications are targeted, backed by possible financial penalty, and more likely to be favorably received by the intended recipients.

Using the aforementioned modified approach creates problems when either the base of subscriber recipients to the system has either not reached a critical mass, or some predefined number associated with economies of scale. As a result, many subscribers may not have the installed software necessary to examine whether bonds accompany messages, and cause the bond to be forfeited for messages that are unwanted. In response, either the ISP may reject unbonded messages by spam filters, or if the messages are bonded, many recipients will not have the ability to impose financial penalties for unwanted messages, and the purpose of the bond will therefore be defeated. Either of the latter two scenarios might be deemed to be untenable with regard an effective system which discourages nuisance spam, allows targeted messages by legitimate senders, but maintains potential penalties to keep senders in line with the policy of not allowing mass vexing communications.

Thus, all of the parties in such a system (e.g., senders, recipients, ISPs, etc.) need to be able to send and receive legitimate (even in reasonably large numbers) communications that are targeted, while not being unduly restrictive due to lack of a large enough installed potential recipient base. Consequently, there is a great need to allow systems for discouraging unwanted electronic communications to be made more efficacious for both those electronic communications recipients who are direct subscribers to the system, and those electronic communication recipients who are not subscribers to the system.

### SUMMARY OF THE INVENTION

In view of the aforementioned problems and deficiencies of the prior art, the present invention provides a method of regulating electronic communications. The method at least includes, via a sender, purchasing a satisfaction bond to be coupled with a communication, the bond being adapted to be forfeited if a recipient of the communication to which the bond is coupled rejects the communication, and sending a message intended for a recipient accompanied by the bond. The bond is established by at least, via the sender, pledging or transferring a res in exchange for the bond, and generating a block of secure data, the secure data comprising a secure certificate containing at least sender identity indicia, a digital signature, a hashing code, and a hash of the message for which the bond is to accompany. The method further at least includes, prior to receipt of the message by the intended recipient, verifying the legitimacy of the bond via a third party, subjecting the message to a filter when the bond is not determined to be legitimate or the message is not accompanied by a bond, the filter being adapted to accept or reject messages based upon predetermined criteria, and not subjecting the message to a filter when the bond is determined to be legitimate.

The present invention also provides a system of regulating electronic communications. The system at least includes message senders, message recipients, at least one third party, and a mechanism for allowing a sender to purchase a satisfaction bond to be coupled with a communication, the bond being adapted to be forfeited if a recipient of the communication to which the bond is coupled rejects the communication. The system also at least includes a bond generator adapted to establish the bond, the bond generator comprising, a res exchanger adapted to allow the sender to pledge or transfer a res in exchange for the bond, and a secure block generator adapted to generate a block of secure data. The secure data at least includes a secure certificate containing at least sender identity indicia, a digital signature, a hashing code, and a hash of the message for which the bond is to accompany. The system also further at least includes a message transmitter adapted to send a message intended for a recipient accompanied by the bond, a bond legitimacy verifier adapted to, prior to receipt of the message by the intended recipient, verifying the legitimacy of the bond via the third party, and a message filter adapted to filter the message when the bond is not determined to be legitimate or the message is not accompanied by a bond, the filter being adapted to accept or reject messages based upon predetermined criteria, and the message filter is adapted to forego filtering the message when the bond is determined to be legitimate.

### BRIEF DESCRIPTION OF THE DRAWING FIGURES

Features and advantages of the present invention will become apparent to those skilled in the art from the description below, with reference to the following exemplary drawing figures, in which:

FIG. 1 is a schematic block diagram of a communication system capable of handling communications according to the present invention;

FIG. 2 is a more detailed version of the bond generator, along with further details of the inventive functions of an Internet Service Provider functioning in accordance with the present invention; and

FIG. 3 is a flowchart of the present-inventive method for regulating communications between communication senders and communication recipients.

### DESCRIPTION OF THE PREFERRED EMBODIMENTS

Method Summary

In the preferred embodiment, an ISP will filter all messages that are not accompanied by a bond, and the filter will reject all messages determined to be unsatisfactory. Properly bonded messages according to the present message will not be subjected to filtering. The bond received with a bonded message can be provided by a bond guarantor for a fee to the sender.

The purchased bond will be integrated into the message communication by the bond issuer, and the bond will consist of an identifier denoting which marketer has caused the bond to issue, along with a unique bond number, and it will also contain text and other information which will appear in the body of the message when it is displayed at the recipient's display screen.

A message sender can either purchase a satisfaction bond from a bond issuer (either by connecting to the bond issuing entity before attempting to send a message, or after being referred to a bond issuing entity when attempting to send an unbonded message), or if previously established according to accepted financial guidelines, can generate its own bond. In any case, the bond is generated in exchange for a thing of value (a “res”) such as money.

In the present-inventive system, an ISP will expect a bonded message to conform to the following convention within the body of the message: a secure certificate at least including a bond number which can be traced to the bond issuer; a block of secure data; a digital signature; a hashing code; and a hash of the associated message. These procedures are required to insure that bonds are genuine, have not been previously used, and that they have not been altered. Further, an ISP receiving a message bonded according to the present invention can have a high degree of confidence that the message is not considered to be spam.

When a recipient opens a bonded e-mail message, a block of secure data is displayed along with a text message indicating that the message is bonded with a guarantee of satisfaction, and that the recipient has recourses if he or she is unsatisfied with the message (e.g., considers the message to be spam). A hyperlink of an Internet web address is also displayed which the recipient can activate and connect to when the message is deemed unsatisfactory.

Connecting to the hyperlinked web site gives the recipient the opportunity to specify that he or she deems the communication unsatisfactory, whereupon the bond seller can take appropriate action against the message sender. The appropriate action can range from forfeiting the res pledged in exchange for the bond, to banning the sender from receiving future bonds from the bond seller, to posting the sender on a list of offending senders which multiple bond sellers check before issuing future bonds.

Because each bond has a unique number, it is easily traceable to the bond issuer. The bond issuer is responsible for keeping track of the identity of the bond purchasers.

General System

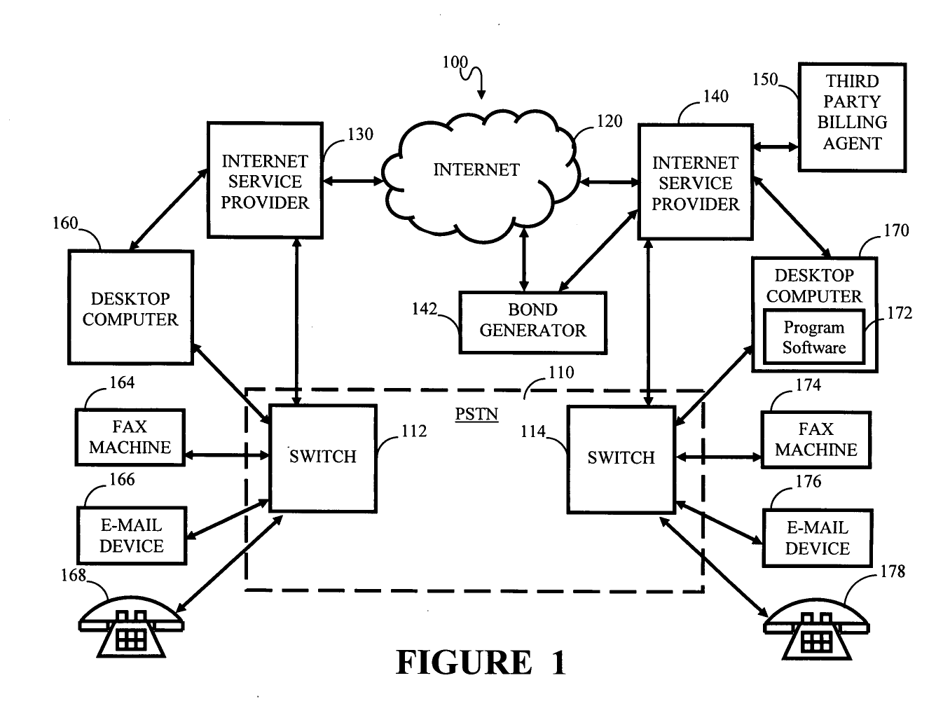

A general schematic block diagram of the present-inventive communication regulation system 100 is shown in FIG. 1. In the system 100, users can both send and receive a variety of electronic communications from a variety of sources, such as from computers (160, 170), facsimile machines (164, 174), special purpose hardware like electronic mail (e-mail) devices, or EMDs (166, 176), and conventional telephones (168, 178). Those skilled in the art to which the invention pertains will appreciate that other devices and other forms of communication can be regulated by the system without departing from the scope of the present invention. Further examples of these communications include “pop-up” menus and third party content messages received while a user is logged on to the Internet. Also, the devices can be connected to the system by both wired and wireless means.

In the preferred embodiment, the system 100 includes a Public Switched Telephone Network (PSTN) 110 for processing telephonic communications emanating from within and without the network. The details of a functioning PSTN are well known to those skilled in the art, and will thus not be repeated here, except to symbolically show telephonic switches 112 and 114. The present invention functions whether the communication is contained entirely within the PSTN, or whether there is extra-network handling. In an alternate embodiment, the connection to the PSTN may be by-passed entirely in favor of a cable modem connection, for communication between the ISP and the desktop computer.

Such extra-network handling includes communications which are transmitted and received through a wide area network (WAN) 120 such as the Internet. Connection to the Internet 120 is by way of one or more Internet Service Providers (ISPs) such as the ones 130 and 140.

A third party billing agent 150 handles financial transactions relating to credit cards and the like.

Users subscribing to the present inventive system and communication regulation service will have program software 172 installed in their computers for receipt of computer communications. Where the user receives a communication without a computer, the program software can be installed as part of the switches 112, 114, and/or as part of an Intelligent Network.

It is also the case that the present invention is applicable to message senders and recipients who are not subscribers to a particular system. A bond seller or bond generating entity 142 will either be contacted by a sender prior to attempting to send a message, or will be contacted after a recipient is informed that a bond is needed to send a particular message to an intended recipient.

The methods associated with the present invention, as described below, can be carried out by one or more communication servers under the control of the system ISPs, with each ISP having a separate server, or one or more centralized system servers.

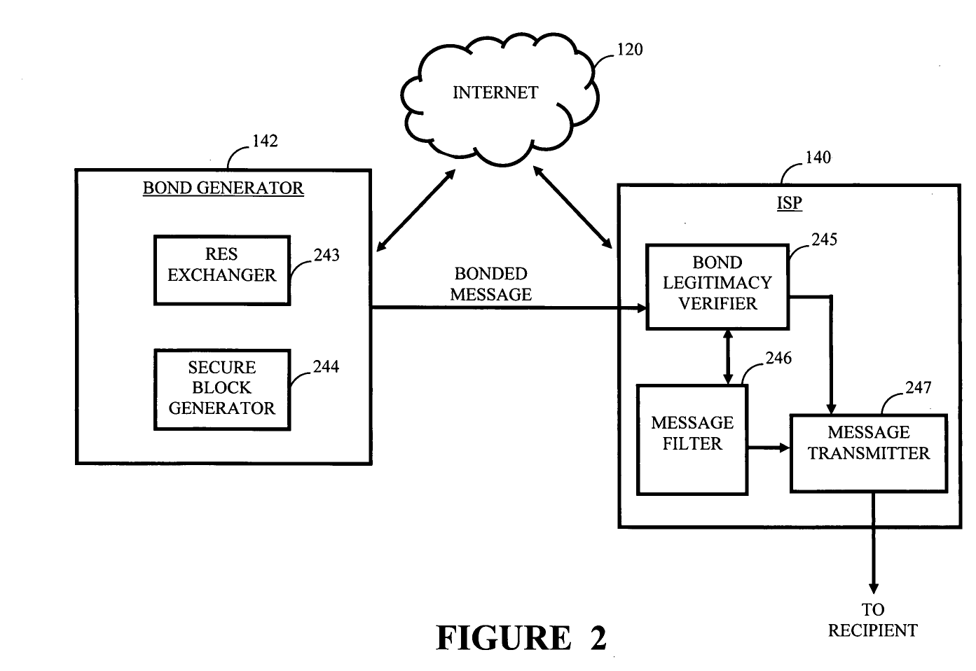

Turning to FIG. 2, a message sender desiring to send an unfiltered message to a recipient using an ISP employing the present invention connects to a bond seller symbolically represented by the number 142. The message sender presents the intended message along with a res (e.g., electronic transfer of money or pledging other collateral) to the seller. A res exchanger 243 exchanges the res from the sender for a bond to be generated.

A secure block generator 244 generates a block of secure data constituting the bond. The bond includes a secure certificate with the identity of the sender. The bond also includes a hashing code and a digital signature to enable verification of its authenticity. As an added security feature, the bond contains a hash of the message for which the bond is to accompany.

The ISP checks incoming messages for an acceptable accompanying satisfaction bond via a bond legitimacy verifier 245. Messages that are unaccompanied by a bond are sent directly to a message filter 246, which can use a number of approaches to filter undesirable messages. The filter 246 is a matter of design choice, with a number of different types being compatible with the teachings of the present invention. A filtered, but acceptable message is transmitted to a message transmitter 247, which in turn forwards the message to the intended recipient. Unacceptable messages are rejected by the filter.

Bonded messages are checked for the legitimacy of their bonds by the bond legitimacy verifier 245. In the preferred embodiment, messages with illegitimate bonds are rejected, without notification to the sender. Legitimately bonded messages bypass the message filter and are directly delivered to the message transmitter 247 for forwarding to the intended recipient.

The legitimacy of the bond is determined by steps such as determining whether the message contains a certificate, determining whether the block of secure data has been altered since its issuance, determining whether the bond has been previously used with another message, and whether the certificate is indeed genuine or legitimate. A failure of any of these tests causes the message to be rejected in the preferred embodiment.

General Method

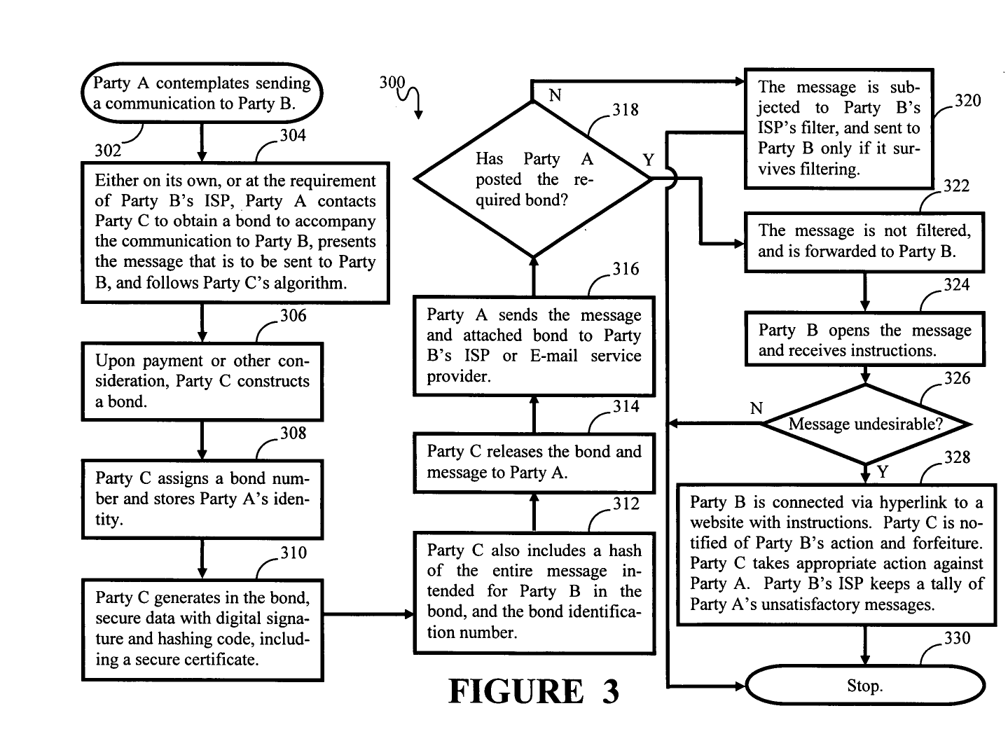

The general algorithm 300 for regulating electronic communication via satisfaction bonds and filters is illustrated in FIG. 3. The algorithm starts when a message sender (Party A) contemplates sending a message to a particular recipient (Party B) in Step 302. In Step 304 Party A contacts a bond seller (Party C) to purchase a satisfaction bond. Party A can contact a bond seller on its own, or if urged to do so by an ISP receiving a message sent to Party B. Party A can have a pre-arrangement with a bond seller, to send bonded messages. Alternatively, Party A can connect to a bond seller from a list of hyperlinks.

Party A follows Party C's procedures to purchase a satisfaction bond. In Step 306, Party A makes payment or exchanges some other consideration for the purchase of a bond. Party C begins to construct the satisfaction bond by assigning a bond number and storing Party A's identity (Step 308). Party C generates secure data with a digital signal and a hashing code, and a secure certificate for inclusion in the satisfaction bond (Step 310). The bond also includes a hash of the message that Party A intends to send (Step 312).

In Step 314 Party C releases the bond and message. Party A sends the bonded message to Party B's ISP in Step 316. Upon receipt of a message, Party B's ISP determines whether a conforming satisfaction bond is included. If so, the message is passed unfiltered to Party B (Steps 318 and 322). If either no bond has been included with the message, or the included bond is non-conforming, the message is subjected to the ISP filter (Steps 318 and Step 320) and either passed on to Party B or rejected, whereupon the algorithm stops (Step 330).

After Step 322 Party B opens the message and receives instructions of recourses if the message is considered by Party B to be unsatisfactory. If the message is satisfactory, the algorithm advances to the end step (330). If Party B considers the message to be unsatisfactory, he or she can be connected via hyperlink to a web site with instructions on possible recourses, including causing Party A's bond to be forfeited (Step 328). Party C may also take other action against Party A. In the preferred embodiment, Party B's ISP also keeps a tally of the number of messages sent by Party A for future use as explained supra.

What is claimed is:

1. A method of regulating electronic communications, said method comprising the steps of:
a) via a sender, purchasing a satisfaction bond to be coupled with a communication, said bond being adapted to be forfeited if a recipient of the communication to which the bond is coupled rejects the communication;
d) establishing said bond comprising:
e) via said sender, pledging or transferring a res in exchange for said bond; and
f) generating a block of secure data, said secure data comprising:
g) a secure certificate containing at least sender identity indicia;
h) a digital signature;
i) a hashing code; and
j) a hash of the message for which said bond is to accompany;
k) sending a message intended for a recipient accompanied by said bond;
l) prior to receipt of said message by the intended recipient, verifying the legitimacy of said bond via a third party;
m) subjecting said message to a filter when said bond is not determined to be legitimate or said message is not accompanied by a bond, said filter being adapted to accept or reject messages based upon predetermined criteria; and
n) not subjecting said message to a filter when said bond is determined to be legitimate.

2. A system of regulating electronic communications, said system comprising:
at least one message sender;
at least one message recipient;
a third party;
a mechanism for allowing a sender to purchase a satisfaction bond to be coupled with a communication, said bond being adapted to be forfeited if a recipient of the communication to which the bond is coupled rejects the communication;
a bond generator adapted to establish said bond, said bond generator comprising:
a res exchanger adapted to allow said sender to pledge or transfer a res in exchange for said bond; and
a secure block generator adapted to generate a block of secure data, said secure data comprising:
a secure certificate containing at least sender identity indicia;
a digital signature;
a hashing code; and
a hash of the message for which said bond is to accompany;
a message transmitter adapted to send a message intended for a recipient accompanied by said bond;
a bond legitimacy verifier adapted to, prior to receipt of said message by the intended recipient, verifying the legitimacy of said bond via said third party; and
a message filter adapted to filter said message when said bond is not determined to be legitimate or said message is not accompanied by a bond, said filter being adapted to accept or reject messages based upon predetermined criteria, and said message filter is adapted to forego filtering said message when said bond is determined to be legitimate.

3. The method of claim 1, further comprising:
associating a unique number with each said bond which identifies the sender.

4. The method of claim 1, wherein elements e) through j) are carried out by a different entity from the sender.

5. The method of claim 1, wherein element l) is carried out by determining whether the message is accompanied by a legitimate certificate.

6. The method of claim 1, wherein element l) is carried out by determining whether the block of secure data has been altered.

7. The method of claim 1, further comprising:
upon receipt of a bonded message by said recipient, informing said recipient that the message is accompanied by a satisfaction bond; and
providing a recourse for the recipient if the recipient is unsatisfied with said message.

8. The method of claim 1, further comprising:
upon receipt of a bonded message by said recipient, informing said recipient that the message is accompanied by a satisfaction bond; and
providing a recourse for the recipient if the recipient is unsatisfied with said message, by referring the recipient to a hyperlinked Internet web site.

9. The method of claim 1, further comprising:
o) upon receipt of a bonded message by said recipient, informing said recipient that the message is accompanied by a satisfaction bond;
p) providing a recourse for the recipient if the recipient is unsatisfied with said message, by referring the recipient to a hyperlinked Internet web site;
q) upon the recipient connecting to said web site, informing the seller of the bond that said message is unsatisfactory; and
r) in response to element q), said seller penalizing said sender.

10. The method of claim 1, further comprising:
when said recipient deems said message unsatisfactory, informing said third party that said message is unsatisfactory.

11. The method of claim 1, further comprising:
when said recipient deems said message unsatisfactory, informing said third party that said message is unsatisfactory; and
said third party keeping a tally of unsatisfactory messages sent by identified senders.

12. The method of claim 1, further comprising:
when said recipient deems said message unsatisfactory, informing said third party that said message is unsatisfactory;
said third party keeping a tally of unsatisfactory messages sent by identified senders; and
said third party taking action against a sender when the number of unsatisfactory messages reaches a predetermined threshold.

13. The method of claim 1, further comprising:
said third party rejecting messages that contain a bond previously inserted into another message.

14. The method of claim 1, further comprising:
said third party rejecting messages that contain a bond that has been altered since being generated.

15. The system of claim 2, wherein said bond generator is further adapted to associate a unique number with each said bond which identifies the sender.

16. The system of claim 2, wherein said bond legitimacy verifier is further adapted to determine whether the block of secure data has been altered.

17. The system of claim 2, further comprising:
said message transmitter is further adapted to, upon receipt of a bonded message by said recipient, inform said recipient that the message is accompanied by a satisfaction bond, and provide a recourse for the recipient if the recipient is unsatisfied with said message, by referring the recipient to a hyperlinked Internet web site;
said web site being adapted to, upon the recipient connecting to it, inform the seller of the bond that said message is unsatisfactory; and
said seller being further adapted to penalize said sender in response.

18. The system of claim 2, further comprising:
said recipient being further adapted to inform said third party of messages received that said recipient deems unsatisfactory;
said third party being further adapted to keep a tally of unsatisfactory messages sent by identified senders; and
said third party being further adapted to take action against a sender when the number of unsatisfactory messages reaches a predetermined threshold.

19. The system of claim 2, further comprising:
said third party being further adapted to reject messages that contain a bond previously inserted into another message.

20. The system of claim 2, further comprising:
said third party being further adapted to reject messages that contain a bond that has been altered since being generated.
